(19) United States
(12) Patent Application Publication
(10) Pub. No.: US 2016/0155276 A1
(43) Pub. Date: Jun. 2, 2016

(54) Method and Apparatus of Dynamically Assigning Parking Lot

(71) Applicant: INSTITUTE FOR INFORMATION INDUSTRY, Taipei (TW)

(72) Inventors: Pao-Chung HO, Taipei City (TW); Kuo-Hua WU, New Taipei City (TW); Jui-Yang TSAI, New Taipei City (TW); Meng-Hsuan CHIA, Taipei City (TW); Wei-Syun LIN, Kaohsiung City (TW); Chih-Min SHIH, New Taipei City (TW)

(21) Appl. No.: 14/557,388

(22) Filed: Dec. 1, 2014

(51) Int. Cl. G07B 15/02

(52) U.S. Cl. CPC G07B 15/02

(57) ABSTRACT

The invention provides a dynamically assigning a parking lot method. First, one or a plurality of parking lots located in a set distance is selected according to a destination provided by the car. Next, a time of parking space to be available is estimated according a real-time parking data and a historical parking data of the one or the plurality of parking lots. Then, a waiting time is estimated according the time of parking space to be available and a car number in a line information of the one or the plurality of parking lots. A driving time of the car to the one or the plurality of parking lots according to a position of the car is estimated. Finally, a total waiting time is estimated according the driving time and the waiting time of the one or the plurality of parking lots.

### BACKGROUND

1. Field of Invention

The invention relates to a method and apparatus for managing a parking lot, and particularly relates to a method and apparatus for dynamically assigning parking lot in real time.

2. Description of Related Art

Typically, a parking lot management system uses an electrical board disposed in the entrance of a parking lot to show the number of available parking spaces. Then, a driver can decide whether or not go to this parking lot according to the information shown in the electrical board. When there are available parking spaces and there is no car waiting in a line, the driver can enter the parking lot immediately; otherwise, the driver has to wait in a line. However, the driver has no way to know how long he or she needs to wait.

For resolving the above problem, a typical method is to calculate a time difference between an average parking time and a time a parking space having been occupied to estimate a time of the parking space to be available to let the driver know the waiting time. However, the typical method does not take the number of the cars waiting in a line into consideration, so that such waiting time is not accurate. Moreover, according to the typical method, the driver only knows the waiting time of a parking lot at the present. If the driver arrives at the parking lot 20 minutes later, he or she needs to keep checking the waiting time information to know the present parking situation. It is very inconvenient for the driver.

Therefore, there is a need for a method and apparatus for dynamically assigning parking lot to a driver in real time.

### SUMMARY

Accordingly, the invention provides a method of dynamically assigning a parking lot to assign a destination parking lot to a car for parking. First, one or a plurality of parking lots located in a set distance is selected according to a destination provided by the car. Next, a time of parking space to be available is estimated according a real-time parking data and a historical parking data of the one or the plurality of parking lots. Then, a waiting time is estimated according the time of parking space to be available and a car number in a line information of the one or the plurality of parking lots. A driving time of the car to the one or the plurality of parking lots according to a position of the car is estimated. Finally, a total waiting time is estimated according the driving time and the waiting time of the one or the plurality of parking lots.

The present invention also provides an apparatus of dynamically assigning a parking lot to assign a destination parking lot to a car to park. The apparatus comprises a parking platform, a first calculating unit, a second calculating unit, and a third calculating unit. The parking platform selects one or a plurality of parking lots located in a set distance according to a destination provided by the car. The first calculating unit estimates a time of parking space to be available according a real-time parking data and a historical parking data of the one or the plurality of parking lots. The second calculating unit estimates a waiting time according the time of parking space to be available and a car number in a line information of the one or the plurality of parking lots. The third calculating unit estimates a driving time of the car to the one or the plurality of parking lots according to a position of the car and for estimating a total waiting time according the driving time and the waiting time of the one or the plurality of parking lots.

Accordingly, the total waiting time not only refers to the time of parking spaces to be available but also refers to the information of the car number in a line in each parking lot and in the parking platform as well as the information of the driving time to each parking lot. Therefore, the total waiting time is really in response to the present situation of each parking lot. A more accuracy total waiting time is estimated.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a flow chart of a method of dynamically arranging parking lot according to an embodiment of the invention;

FIG. 2 illustrates a flow chart to estimate the waiting time for a parking lot according to an embodiment of the invention;

FIG. 3 illustrates a schematic diagram to estimate the car number in a line for a parking lot according to an embodiment of the invention;

FIG. 4 illustrates a time chart of the waiting time for a parking lot according to an embodiment of the invention;

FIG. 5 illustrates a schematic diagram of an apparatus of dynamically arranging the parking lot according to an embodiment of the invention; and

FIG. 6 illustrates a schematic diagram of a first estimate unit for according to an embodiment of the invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

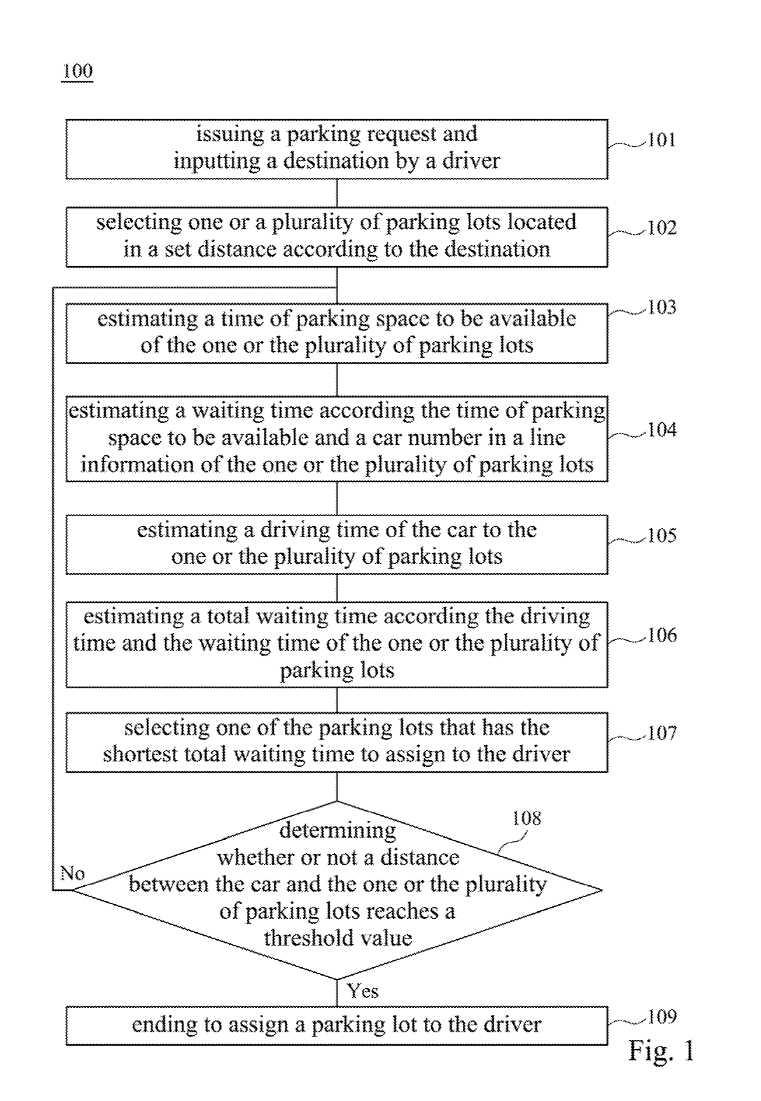

FIG. 1 illustrates a flow chart of a method for dynamically arranging parking lot according to an embodiment of the invention. According to the method 100 for dynamically arranging parking lot, the driver issues a parking request as well as his destination in step 101. In an embodiment a driver issues his parking request as well as his destination in a parking platform. The parking platform is a network platform that is constructed in a server. The driver can wireless communicates with the server through a portable device to log in the parking platform to issue his parking request as well as his destination.

In step 102, the apparatus will search the parking lots located near the destination. According to the destination provided by the driver, the server will search a database to find out one or many parking lots located in a set distance from the destination to act as the parking lots to dynamically assign to the driver. It is possible that there is no parking lot in the destination. Therefore, the driver can set an acceptable walking distance from the destination to act as the set distance. Then, the server will search a database to find out one or many parking lots according to the set distance. The parking lots out of the set distance will be excluded from this search For example, the driver can set that the acceptable walking distance is 1 Km form the destination. Therefore, the destination is a center and the 1 Km is a radius to form the searching range for the server to find out parking lots is a database. In another embodiment, the driver can set an acceptable walking time from the destination to act as the set distance. For example, the driver can set that the acceptable walking time is 10 min form the destination. The set distance method does not be limited in the above embodiments. Other methods can be also used to set the set distance for the server to find out parking lots.

After the server finds out the parking lots in step 102, the time for parking space to be available in each parking lot is estimated in step 103. The waiting time according to the car number in a line and the time for parking space to be available in each parking lot are estimated in step 104. In an embodiment, the car number in a line includes the number of the car in a line of each parking lot and the number of the car issuing parking request in the parking platform. The driving time to each parking lot is estimated in step 105. Then, a total waiting time is estimated in step 106 according to the waiting time in step 104 and the driving time in step 105. The total waiting time is the total time for the driver from his present driving position to enter each parking lot. That is, the total waiting time equals the waiting time plus the driving time. Next, in step 107, according to the total waiting time in each parking lot, a shortest total waiting time is selected. That is, the parking lot having the shortest total waiting time is selected and assigned to the driver. Then, the driver can drive his car to the parking lot to park. However, because the number of car in a line in each parking lot, the number of the car issuing parking request in the parking platform, the number of the car leaving parking lot, and the driving time to each parking lot are changeable at moments, the step 103 to step 107 are automatically repeatedly performed in response to the changing data and assigning a latest selected parking lot to the driver until the distance between the car and the destination reaches a threshold distance. At this time, the selected parking lot is the destination parking lot for the driver. Therefore, in step 108, a determination step is performed to determine whether or not the distance between the car and the destination reaches a threshold distance. Once the distance between the car and the destination reaches the threshold distance, the step 109 is performed to set the parking lot that is assigned to the driver finally to act as the destination parking lot and to indicate the driver to drive to this parking lot. Because the total waiting time is automatically renewed according to the latest data, it is not necessary for the driver to require these data manual. Moreover, the total waiting time further refers to the information of the car number in a line in each parking lot and in the parking platform in step 104 and the information of the driving time to each parking lot in step 105. Therefore, the total waiting time is really in response to the present situation of each parking lot. That is, a more accuracy total waiting time is estimated. The driver can plan his travel accurately. Accordingly, the total waiting time is equal to that the time for parking space to be available in each parking lot in step 103, adds the waiting time according to the car number in a line in each parking lot and in the parking platform in step 104, adds the driving time to each parking lot in step 105. The detailed description is described in the following paragraphs.

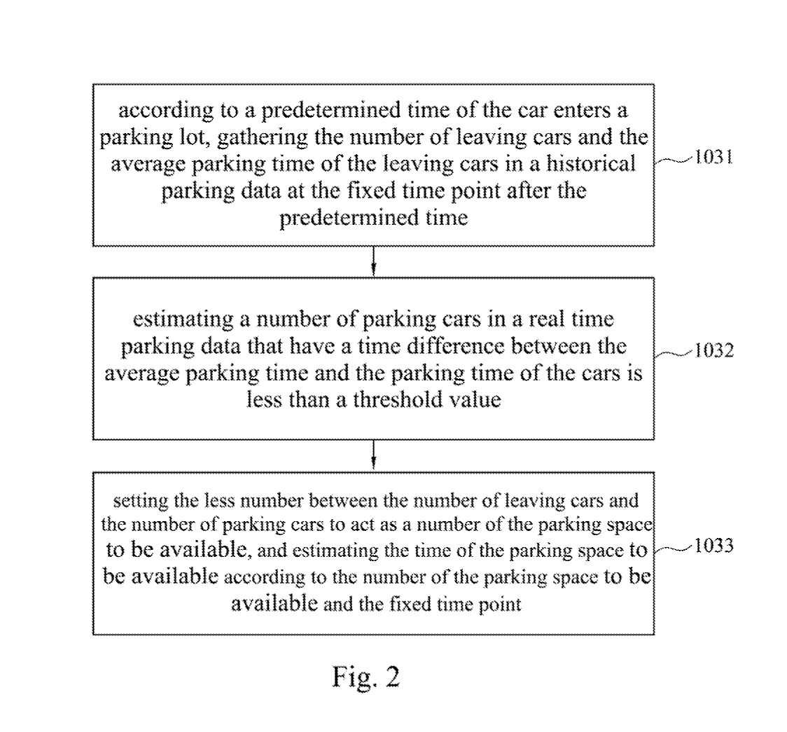

In step 103, the time for parking space to be available in each parking lot is estimated. FIG. 2 illustrates a flow chart to estimate the waiting time for a parking lot according to an embodiment of the invention. In this step, it is supposed that there is no car in a line in the parking lot and there is also no parking space available in the parking lot. Accordingly, in step 1031, according to a predetermined time for a car that wants to enter the parking lot, a parking data at a fixed time point after the predetermined time in a historical parking data is gathered. The parking data includes a leaving car number of leaving the parking lot and an average parking time of the leaving car parking in the parking lot. The historical parking data includes the parking state and the average parking time on each fixed time point in one day. In an embodiment, the fixed time point is a fixed time session in one day, such as every 1 min in one day. However, in another embodiment, the fixed time point is every 5 min in one day, every 10 min in one day or at every 1 sec in one day. In the following embodiment, the fixed time point is every 1 min in one day he in one day. Accordingly, the number of parking space to be available at every 1 min in one day of a parking lot is estimated according to the leaving car number and an average parking time of the leaving car at every 1 min in one day. In other words, the leaving car number and an average parking time of the leaving car at 00:01, 00:02, 00:03, . . . 24:59, 00:00 are calculated respectively. For example, five cars leave the parking lot at 4:10, and the average parking time of the five cars is 45 min. Ten cars leave the parking lot at 4:11, and the average parking time of the ten cars is 30 min. Two cars leave the parking lot at 4:12, and the average parking time of the two cars is 40 min. It is noticed that the fixed time point is every 5 min in one day, every 10 min in one day or at every 1 sec in one day in other embodiment. Moreover, some cars just drive into a parking lot, then, leave the parking lot immediately, or some cars have parked in a parking lot for a long time. These unreasonable parking affects the accuracy of parking data. Therefore, data generated by these unreasonable parking is removed when estimating the parking data. In an embodiment, two-times standard deviation is used to filter the data. That is, only the data located in the two times standard deviation is used to estimate the leaving car number of leaving the parking lot and an average parking time of the leaving car parking in the parking lot. In step 1032, a real time parking data is gathered. That is, a having parked time of each car having parked until now in the parking lot is gathered according to the real time parking data. Then, a now parking number of a car having a time difference between its having parked time and the average parking time is less than a threshold value is estimated. Then, in step 1033, the less one of the leaving car number and the now parking number is selected to act as the number for parking space to be available in the parking lot. Then, the time for parking space to be available in the parking lot is estimated according to the number for parking space to be available and the fixed time point.

In an embodiment, a driver wants to park in a parking lot at 4:10. However, there is no parking space provided now. According to the historical parking data, ten cars will leave the parking lot at 4:11 The average parking time of the ten cars is 30 min. According to the real time parking data, four cars have parked for 30 min until now. That is, the having parked time of the four cars is 30 min. Moreover, the time difference between the average parking time of the historical parking data and the having parked time of the four cars of the real time parking data is less than a threshold value. Therefore, the now parking number is four. Accordingly, according to the historical parking data, it is supposed that the four cars will leave the parking lot. That is, after the fixed time point, 1 min, four parking space is provided at 4:11. Moreover, according to the fixed time point, 1 min, and the leaving car number, four cars, the average time for the cars to leave the parking lot is 12 sec. That is, the estimated time for the first car to leave the parking lot is at 4:11′12. The estimated time for the second car to leave the parking lot is at 4:11′24. The estimated time for the third car to leave the parking lot is at 4:11′36. The estimated time for the fourth car to leave the parking lot is at 4:11′48. It is noticed that, in another embodiment, the time difference between the average parking time of the historical parking data and the having parked time of the cars of the real time parking data is compared with a threshold value. As long as the absolute value of the time difference is less than the threshold value, it is supposed that these cars will leave the parking lot. In an embodiment, the threshold value is 5 min. Therefore, it is supposed that the cars whose having parked time are 25 min to 35 min will leave the parking lot. In another embodiment, the threshold value is a percentage of the average parking time of the historical parking data. On the other hand, it is supposed that the number of the cars whose having parked time is 30 min is eleven. That is, there are eleven cars whose time difference between the average parking time of the historical parking data and their having parked time is less than the threshold value. Therefore, the now parking number is eleven. However, the now parking number, eleven, is larger than the historical leaving car number, ten. Therefore, the less one of the leaving car number and the now parking number is selected to act as the number for parking space to be available in the parking lot. That is, the historical leaving car number, ten, is selected to act as the number for parking space to be available in the parking lot.

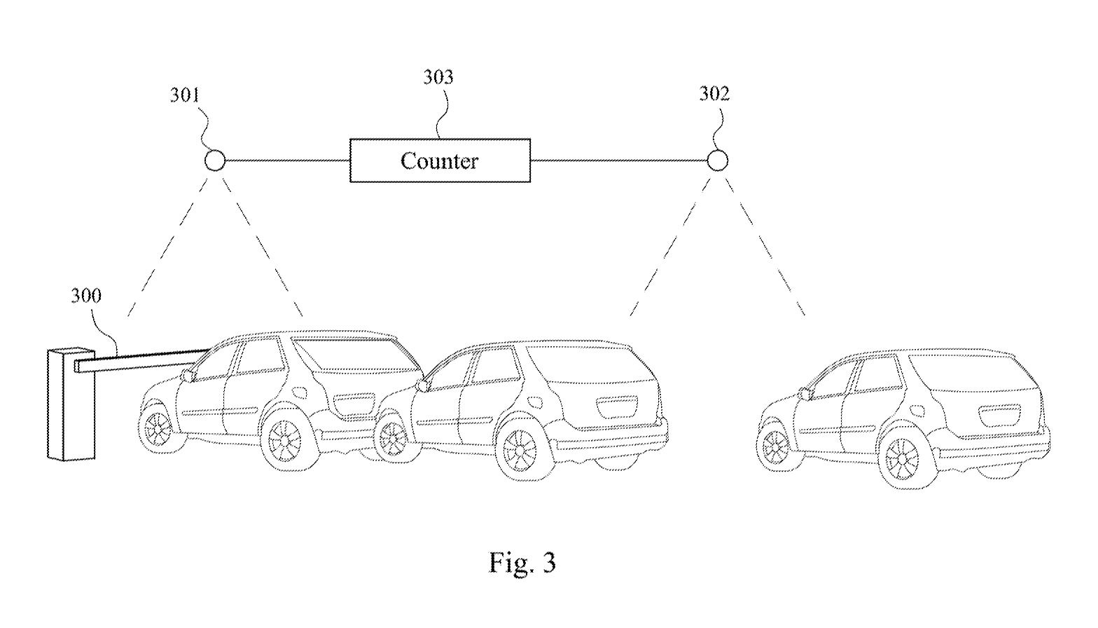

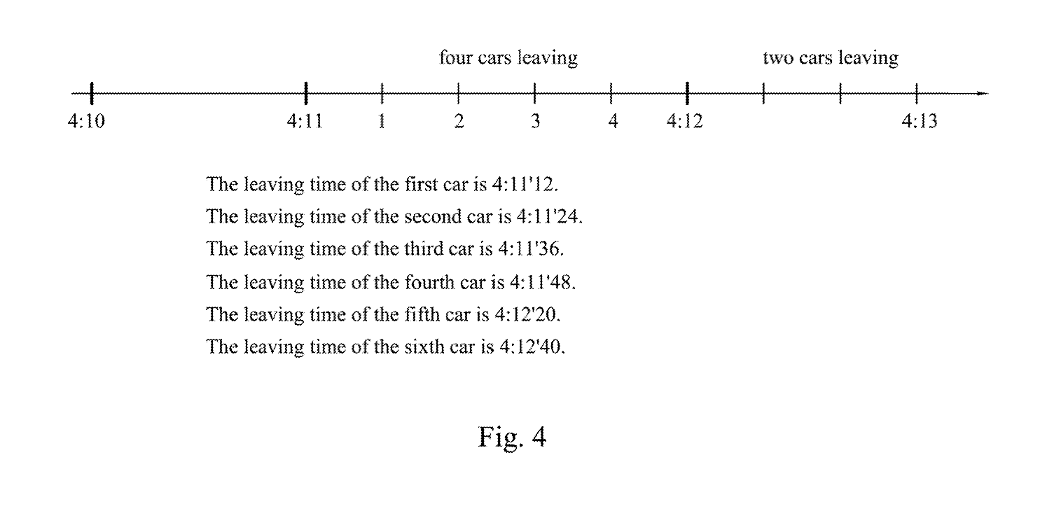

In step 104, the waiting time according to the car number in a line in each parking lot is estimated. FIG. 3 illustrates a schematic diagram to estimate the car number in a line for a parking lot according to an embodiment of the invention. There are two sensors 301 and 302 and a counter 303 disposed at the entrance 300 of the parking lot. The sensors 301 and 302 couple with the counter 303. The sensor 301 is disposed at the entrance 300. The sensor 302 is disposed away from the sensor 301. The sensor 301 and the sensor 302 define a path for a car line. The sensor 302 senses the number of car driving in the car line. The sensor 301 senses the number of car leaving the car line to enter the parking lot. In an embodiment, when a car passes through the sensor 302 to enter the car line, the counter 303 is increased by one. When a car passes through the sensor 301 to enter the parking lot, the counter 303 is decreased by 1. Accordingly, the number of the car in the car line between the sensors 301 and 302 is calculated. Then, the accuracy waiting time according to the car number in the car line in the parking lot can be estimated. In an embodiment, the accuracy waiting time is equal to the car number in the car line multiplied by the average time entering the parking lot, the time for parking space to be available. FIG. 4 illustrates a time chart of the waiting time for a parking lot according to an embodiment of the invention. In an embodiment, a driver wants to park in a parking lot at 4:10. However, there is no parking space provided now. According to the historical parking data and the real time parking data, four cars will leave the parking lot at 4:11. That is, after the fixed time point, 1 min, four parking spaces are provided at 4:11. According to the fixed time point, 1 min, the four cars sequentially leave the parking lot in 1 min. Therefore, the average time for the cars to leave the parking lot is 12 sec. As shown in FIG. 4, That is, the estimated time for the first car to leave the parking lot is at 4:11′12. The estimated time for the second car to leave the parking lot is at 4:11′24 The estimated time for the third car to leave the parking lot is at 4:11′36. The estimated time for the fourth car to leave the parking lot is at 4:11′48. Because after one car leaves the parking lot, the first car in the car line can enter the parking lot. Therefore, the time for a car entering the parking lot can be set to equal to the time for a car leaving the parking lot. That is, the estimated time for the first car to enter the parking lot is at 4:11′12. The estimated time for the second car to enter the parking lot is at 4:11′24. The estimated time for the third car to enter the parking lot is at 4:11′36. The estimated time for the fourth car to enter the parking lot is at 4:11′48. In other words, if the driver's care is the fourth car in the car line, the driver's car can enter the parking lot will be at 4:11′48. In another embodiment, the driver's care is the fifth car in the car line. According to the historical parking data and the real time parking data, four cars will leave the parking lot at 4:11 and two cars will leave the parking lot at 4:12. That is, after 2 min, two parking spaces are provided at 4:12. Because the driver's care is the fifth car in the car line, the estimated time for the fifth car to leave the parking lot is at 4:12′20. Therefore, the time for the driver's car to enter the parking lot is at 4:12′20. In further embodiment, the driver's car arrives the parking lot is at 4:25. Three cars issuing parking request in the parking platform will also arrive the parking lot at 4:20. At this time, the three cars will be added into the car line at 4:20 to estimate the waiting time. That is, the car number in the car line at 4:20 includes the physical cars in the car line and the cars issuing parking request in the parking platform to estimate the time to enter the parking lot.

In step 105, the driving time is estimated. That is, the time from the present position of the car to the parking lot is estimated. In an embodiment, an apparatus with GPS function is used to estimate the time from the present position of the car to the parking lot. The driving time is considered when estimating the total waiting time. In an embodiment, the driver drives the car at 4:10. The driving time to the parking lot is 15 min. Therefore, the estimated arriving time to the parking lot is at 4:25. Accordingly, the real time parking data of the parking lot is continuously compared with the historical parking data during the driving time to estimate the parking space to be available. That is, the parking space to be available will be changed according to the change of the real time parking data of the parking lot during the driving time.

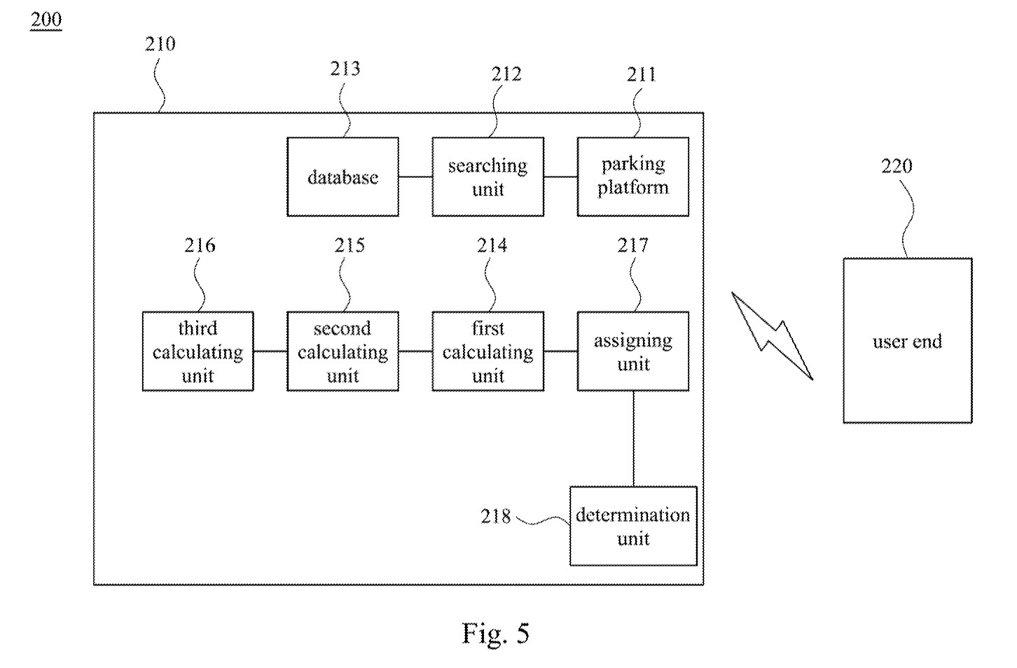

FIG. 5 illustrates a schematic diagram of an apparatus to dynamically arranging the parking lot according to an embodiment of the invention. The apparatus 200 to dynamically arranging the parking lot includes a server end 210 and a user end 220. A parking platform 211 is a network platform that is constructed in the server end 210. The driver can wireless communicates with the server end 210 through the user end 220, such as a portable device, to log in the parking platform 211 to issue parking request as well as his destination.

The server end 210 further includes a searching unit 212, a database 213, a first calculating unit 214, a second calculating unit 215, a third calculating unit 216 and an assigning unit 217. The searching unit 212 will search the parking lots located near the destination. According to the destination provided by the driver in the parking platform 211, the searching unit 212 will search the database 213 to find out one or many parking lots located in a set distance from the destination to act as the parking lots to dynamically assign to the driver. According to the parking lots searched by the searching unit 212, the first calculating unit 214 estimates the time for a parking space to be available in each parking lot according to a historical parking data and a real time parking data. The second calculating unit 215 estimates the waiting time according to the car number in a line and the time for parking space to be available in each parking lot. In an embodiment, the car number in a line includes the number of the car in a line of each parking lot and the number of the car issuing parking request in the parking platform 211. The third calculating unit 216 estimates a driving time from the present position of the car to each parking lot. In an embodiment, a apparatus with GPS function is used to get the present position of the car. Then, the third calculating unit 216 estimates a total waiting time according to the waiting time estimated by the second calculating unit 215 and the driving time. An assigning unit 217 selects a parking lot having the shortest total waiting time, that is, the driver can enter the parking lot in a shortest time, to assign to the user end 220. Because the number of car in a line in each parking lot, the number of the car issuing parking request in the parking platform 211, the number of the car leaving the parking lot, and the driving time to each parking lot are changeable at moments, the first calculating unit 214, the second calculating unit 215 and the third calculating unit 216 automatically repeatedly estimate the total waiting time in response to the changing data until the distance between the car and the destination reaches a threshold distance. Therefore, the apparatus 200 to dynamically arranging the parking lot further includes a determination unit 218 to determine whether or not the distance between the car and the destination reaches a threshold distance. Once the distance between the car and the destination reaches the threshold distance, the determination unit 218 indicates the assigning unit 217 to assign the parking lot having shortest total waiting time to the driver to act as the destination parking lot.

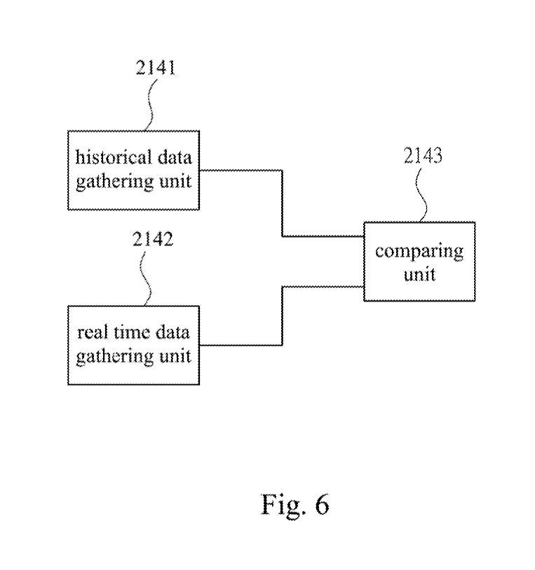

FIG. 6 illustrates a schematic diagram of a first estimate unit for according to an embodiment of the invention. The first calculating unit 214 further includes a historical data gathering unit 2141, a real time data gathering unit 2142 and a comparing unit 2143. The historical data gathering unit 2141 gathers a historical parking data at a fixed time point after the predetermined time in a historical parking data. The parking data includes a leaving car number of leaving the parking lot and an average parking time of the leaving car parking in the parking lot. For example, the historical data gathering unit 2141 gathers a historical parking data of a parking lot stored in the database 213. The historical parking data includes the parking state and the average parking time on each fixed time point in one day. In an embodiment, the fixed time point is a fixed time session in one day, such as every 1 min in one day. Accordingly, the leaving car number and an average parking time of the leaving car at every 1 min in one day is estimated. A real time data gathering unit 2142 gathers the real time parking data of the parking lot to estimate a having parked time of each car having parked until now in the parking lot. Then, a now parking number of a car having a time difference between its having parked time and the average parking time is less than a threshold value is estimated. A comparing unit 2143 compares the real time parking data with the historical parking data to get the parking spaces to be available. That is, the comparing unit 2143 compares the leaving car number in the historical parking data with the now parking number in the real time parking data to select the less number to act as the number for parking space to be available in the parking lot. Then, the time for parking space to be available in the parking lot is estimated according to the number for parking space to be available and the fixed time point.

In an embodiment, the historical data gathering unit 2141 gathers a historical parking data of a parking lot stored in the database 213. According to the historical parking data, ten cars will leave the parking lot at 4:11. The leaving car number is ten. The average parking time of the ten cars is 30 min. The real time data gathering unit 2142 gathers a real time parking data of the parking lot. According to the real time parking data, four cars have parked for 30 min until now. That is, the now parking number is four. The comparing unit 2143 compares the leaving car number, ten, in the historical parking data with the now parking number, four, in the real time parking data. The less number, the now parking number, four, is selected to act as the number for parking space to be available in the parking lot. That is, after the fixed time point, 1 min, four parking spaces will be provided at 4:11. Moreover, according to the fixed time point, 1 min, and the leaving car number, four cars, the comparing unit calculates the average time for the cars to leave the parking lot is 12 sec. That is, the estimated time for the first car to leave the parking lot is at 4:11′12. The estimated time for the second car to leave the parking lot is at 4:11′24. The estimated time for the third car to leave the parking lot is at 4:11′36. The estimated time for the fourth car to leave the parking lot is at 4:11′48.

Accordingly, in the present invention, the total waiting time not only refers to the time of parking spaces to be available but also refers to the information of the car number in a line in each parking lot and in the parking platform as well as the information of the driving time to each parking lot. Therefore, the total waiting time is really in response to the present situation of each parking lot. A more accuracy total waiting time is estimated.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method of dynamically assigning a parking lot for assigning a destination parking lot to a car, comprising:
(a) selecting one or a plurality of parking lots located in a set distance according to a destination provided by the car;
(b) estimating a time of parking space to be available according a real-time parking data and a historical parking data of the one or the plurality of parking lots;
(c) estimating a waiting time according the time of parking space to be available and a car number in a line information of the one or the plurality of parking lots;
(d) estimating a driving time of the car to the one or the plurality of parking lots according to a position of the car; and
(e) estimating a total waiting time according the driving time and the waiting time of the one or the plurality of parking lots.

2. The method of dynamically assigning a parking lot of claim 1, in case of the plurality of parking lots being selected in step (a), further comprising:
(f) selecting one of the plurality of parking lots that has the shortest total waiting time to assign it to the car.

3. The method of dynamically assigning a parking lot of claim 2, further comprising:
determining whether or not a distance between the car and the one or the plurality of parking lots reaches a threshold value,
wherein when the distance reaches the threshold value, a parking lot that has the shortest total waiting time is selected to assign to the car; and
when the distance does not reach the threshold value, performing the step (b) to the step (f) again.

4. The method of dynamically assigning a parking lot of claim 1, wherein the real-time parking data comprises a parking time of each car having parked until now in the one or the plurality of parking lots.

5. The method of dynamically assigning a parking lot of claim 4, wherein the historical parking data comprises a number of leaving cars and an average parking time of the leaving cars in the one or the plurality of parking lots at each of a plurality of fixed time points in one day.

6. The method of dynamically assigning a parking lot of claim 5, wherein each of the plurality of fixed time points is a fixed time session.

7. The method of dynamically assigning a parking lot of claim 5, wherein cars with parking time located in two times standard deviation are used to estimate the number of leaving cars and the average parking time of the leaving cars.

8. The method of dynamically assigning a parking lot of claim 5, wherein the step (b) further comprising:
according to a predetermined time of the car enters the one or the plurality of parking lots, gathering the number of leaving cars and the average parking time of the leaving cars in the historical parking data at the fixed time point after the predetermined time;
according to the average parking time of the leaving cars, estimating a number of parking cars in the real time parking data that have a time difference between the average parking time and the parking time of the cars is less than a threshold value;
gathering the less number between the number of leaving cars and the number of parking cars to act as a number of the parking space to be available; and
estimating the time of the parking space to be available according to the number of the parking space to be available and the fixed time point.

9. The method of dynamically assigning a parking lot of claim 8, wherein the threshold value is a percentage of the average parking time of the leaving cars.

10. The method of dynamically assigning a parking lot of claim 1, wherein the car number in a line information is a number of cars in a line of the one or the plurality of parking lots.

11. The method of dynamically assigning a parking lot of claim 1, wherein the car number in a line information is a number of cars in a line of the one or the plurality of parking lots and a number of cars providing the destination.

12. An apparatus of dynamically assigning a parking lot, wherein a destination parking lot is assigned to a car to park, comprising:
a parking platform for selecting one or a plurality of parking lots located in a set distance according to a destination provided by the car;
a first calculating unit for estimating a time of parking space to be available according a real-time parking data and a historical parking data of the one or the plurality of parking lots;
a second calculating unit for estimating a waiting time according the time of parking space to be available and a car number in a line information of the one or the plurality of parking lots; and
a third calculating unit for estimating a driving time of the car to the one or the plurality of parking lots according to a position of the car and for estimating a total waiting time according the driving time and the waiting time of the one or the plurality of parking lots.

13. The apparatus of dynamically assigning a parking lot of claim 12, further comprising an assigning unit,
wherein when the parking platform selects the plurality of parking lots, the assigning unit selects one of the plurality of parking lots that has the shortest total waiting time to assign to the car.

14. The apparatus of dynamically assigning a parking lot of claim 12, further comprising a determination unit to determine whether or not a distance between the car and the one or the plurality of parking lots reaches a threshold value,
wherein when the determination unit determine the distance reaching the threshold value, a parking lot that has the shortest total waiting time is selected to assign to the car; and
when the determination unit determine the distance does not reach the threshold value, the first calculating unit, the second calculating unit and the third calculating unit calculate the time of parking space to be available, the waiting time and the total waiting time again.

15. The apparatus of dynamically assigning a parking lot of claim 12, wherein the first calculating unit further comprises a real-time parking data gathering unit to gather a parking time of each car having parked until now in the one or the plurality of parking lots to act as the real-time parking data.

16. The apparatus of dynamically assigning a parking lot of claim 15, wherein the first calculating unit further comprises a historical parking data gathering unit to gather a number of leaving cars and an average parking time of the leaving cars in a database of the one or the plurality of parking lots at each of a plurality of fixed time points in one day to act as the historical parking data.

17. The apparatus of dynamically assigning a parking lot of claim 16, wherein each of the plurality of fixed time points is a fixed time session.

18. The apparatus of dynamically assigning a parking lot of claim 16, wherein the first calculating unit further comprises a comparing unit, wherein
according to a predetermined time of the car enters the one or the plurality of parking lots, the historical parking data gathering unit gathers the number of leaving cars and the average parking time of the leaving cars in the historical parking data at the fixed time point after the predetermined time;
according to the average parking time of the leaving cars, the real time parking data gathering unit estimates a number of parking cars in the real time parking data that have a time difference between the average parking time and the parking time of the cars is less than a threshold value;
the comparing unit compares the number of leaving cars with the number of parking cars to select the less number to act as a number of the parking space to be available, and estimates the time of the parking space to be available according to the number of the parking space to be available and the fixed time point.

19. The apparatus of dynamically assigning a parking lot of claim 12, further comprising a searching unit coupling with the parking platform, wherein the searching unit searches the one or the plurality of parking lots according to the destination provided by the car.

20. The apparatus of dynamically assigning a parking lot of claim 12, wherein the car number in a line information is a number of cars in a line of the one or the plurality of parking lots, further comprising:
a first sensor disposing on an entrance of the one or the plurality of parking lots to sense a number of cars entering the one or the plurality of parking lots;
a second sensor disposing away from the first sensor, wherein the first sensor and the second sensor define a path of the line to sense a number of cars entering the car line; and
a counter coupling with the first sensor and the second sensor to count the car number in the line,
wherein when one car passes through the second sensor, the counter is increased by 1; and when one car passes through the first sensor, the counter is decreased by 1.
